(19) United States
(12) Patent Application Publication
(10) Pub. No.: US 2008/0050298 A1
(43) Pub. Date: Feb. 28, 2008

(54) Method For Improving the HF Capture Efficiency of Dry Scrubbers

(76) Inventors: Hendrik J. van der Meyden, Summerville, SC (US); Neal Richard Dando, Murrysville, PA (US); Stephen Joseph Lindsay, Maryville, TN (US)

Correspondence Address: Harry A. Hild, Jr.;Intellectual Property, Alcoa Technical Center, 100 Technical Drive, Alcoa Center, PA, 15069-0001, US

(21) Appl. No.: 11/466,793

(22) Filed: Aug. 24, 2006

(51) Int. Cl. B01D 53/68

(52) U.S. Cl. 423/240 S; 423/241

(57) ABSTRACT

The present invention provides, a method of reducing fluoride emissions from aluminum smelting including the steps of providing alumina at a preselected feed rate to pots containing an aluminum producing molten electrolyte, wherein the aluminum producing molten electrolyte evolves gaseous fluoride byproducts; transporting the gaseous fluoride byproducts to alumina-based dry scrubbers, wherein the alumina scrubbers absorb at least a portion of the gaseous fluoride byproducts; determining the inlet temperature into the dry scrubber; and adjusting the alumina feed rate to the dry scrubber to optimize the capture efficiency of the gaseous fluoride byproducts, wherein adjusting the aluminum feed rate includes increasing the aluminum feed rate to correspond to a first temperature and decreasing the feed rate to correspond to a second temperature, wherein the first temperature is greater than the second temperature.

### FIELD OF THE INVENTION

The present invention relates to a process for improving the recovery of gaseous hydrogen fluoride (HF) from aluminum smelter exhaust gases in an efficient and expeditious manner by contacting the gas with alumina.

### BACKGROUND OF THE INVENTION

The aluminum smelting process evolves significant amounts of hydrogen fluoride, and particulate fluoride including bath fines as an inherent part of the process. Hydrogen fluoride is considered to be a hazardous air pollutant and is currently regulated in most of the world. Fluoride emissions from aluminum smelters are captured by captive ducting systems and the fluoride is removed from the gas stream using fluidized bed (Alcoa A-398) or injection-based dry scrubber technology. These scrubbers use smelting grade alumina (SGA) as the active adsorbent. After use the alumina that has reacted with fluoride is fed to the smelting pots, thereby returning the fluoride to the process.

Dry scrubber operations are based on a fixed year round alumina consumption rate corresponding to the performance conditions measured from the commissioning of the dry scrubber. The capture efficiency of dry scrubber increases as the new alumina feed rate is increased, relative to a fixed ingress rate of HF. The maximum sustainable new alumina feed rate is limited to the “alumina-demand” of the smelter. This is equal to the rate of alumina consumption required by all of the active pots in the smelter. The new alumina feed rate may be set to the maximum sustainable throughput corresponding to the alumina demand of the smelter. A need exists for a means to improve the efficiency of smelter dry scrubbers in reducing HF emissions.

### SUMMARY OF THE INVENTION

Generally speaking, in accordance with the present invention, a method is provided for improving aluminum smelter dry scrubber efficiency by deliberately varying the new alumina feed rate in a manner that provides more alumina during warmer periods and less alumina during cooler periods. Broadly, the present method comprises the steps of:
providing alumina at a preselected feed rate to pots containing an aluminum producing molten electrolyte, wherein the aluminum producing molten electrolyte evolves gaseous fluoride byproducts;
transporting gaseous fluoride byproducts to alumina-based dry scrubbers, wherein the alumina dry scrubbers absorb at least a portion of the gaseous fluoride byproducts; determining the inlet temperature into the dry scrubber; and
adjusting the alumina feed rate to the dry scrubber to optimize the capture efficiency of the gaseous fluoride byproducts, wherein adjusting the aluminum feed rate includes increasing the aluminum feed rate to correspond to a first temperature and decreasing the feed rate to correspond to a second temperature, wherein the first temperature is greater than the second temperature.

It has been determined that the efficiency of smelting grade alumina (SGA) based dry scrubbers is impacted by ambient temperature and humidity. In warmer periods, the first temperature, the fluoride emissions measured at the exhaust stack of the dry scrubber are higher than those observed during cooler periods, the second temperature. The warmer periods having increased fluoride emissions (reduced dry scrubber efficiency) are representative of a first gas inlet temperature to the dry scrubber corresponding to daylight hours, and the colder periods representative of reduced fluoride emissions (increased dry scrubber efficiency) are typically representative of a second inlet temperature to the dry scrubber corresponding to hours after sunset, wherein the temperatures corresponding to the warmer and cooler portions depend upon geographic location and season. On a short term basis, this variation can be observed on a periodic, diurnal cycle, where exhaust stack fluoride emissions are correlated to ambient temperature (which is normally highest during daylight hours).

In one embodiment, the alumina feed rate to the dry scrubber is adjusted from a base alumina feed rate to the dry scrubber that corresponds to the alumina demand of the smelter. The alumina demand of the smelter is defined as the total alumina (tons per day) required by the smelting pots served by the dry scrubber for the production of aluminum and is at least dependent upon the size and number of pots. The base alumina feed rate to the dry scrubber is defined as a constant rate in which new alumina is fed to the dry scrubber at a rate equivalent to the alumina demand of the pots served by the dry scrubber over 24 hours. In one embodiment, adjusting the alumina feed rate comprises increasing the alumina feed rate by up to approximately 25%, preferably up to 20%, corresponding to the first temperature and decreasing the alumina feed rate by up to approximately 25%, preferably up to 20%, from the base alumina feed rate corresponding to the second temperature.

The reduction in scrubbing efficiency observed with increased gas inlet temperature results from a reduction in mass transfer efficiency of gaseous HF to the alumina surface. More pronounced reductions in the capture efficiency of the dry scrubber occur when dry scrubber inlet temperature approaches or exceeds the boiling point of water (100 C or 212 F). This latter observation is because alumina is hygroscopic and readily adsorbs water from the air during transport to the plant and transport (often on moving belts or air slides) to the dry scrubber. As the inlet alumina is heated to elevated temperatures in the dry scrubber, such as greater than 100° C. or 212° F., the adsorbed moisture vaporizes off the surface of the alumina. This release of surface moisture can effectively “steam” adsorbed fluoride off the surface of the alumina, thereby further compromising the capture efficiency of the dry scrubber.

In one aspect of the present invention, the aluminum feed rate is adjusted to correspond to the inlet temperature to the dry scrubber and hence optimize the gaseous fluoride byproduct capture efficiency of the alumina, wherein the inlet temperature corresponds to time and season. For the purposes of this disclosure, in one embodiment, the term “optimize the recapture efficiency of gaseous fluoride byproducts” denotes that the alumina feed rate is increased to compensate for the reduction in capture efficiency of alumina, which at least partially results from the reduction in mass transfer efficiency of gaseous HF to the alumina surface and from fluoride being released through the vaporization of moisture from the surface of reacted alumina at temperatures on the order of 100° C. (212° F.). In one embodiment, the alumina feed rate to the dry scrubber is increased when the temperature in the gas inlet to the dry scrubber reaches approximately or greater than 200° F. (93° C.).

In one embodiment, the aluminum feed rate is adjusted to correspond to the diurnal cycle of the dry scrubber. The term “diurnal cycle” denotes an increasing new alumina feed rate during daylight hours and decreasing new alumina feed rate during evening hours. The daylight hours correspond to a first temperature range and the evening hours correspond to a second temperature range, wherein the first temperature range has higher values than the second temperature range and are partially dependent upon geographic location. The feed rate changes would be balanced so that the same total weight of alumina was reacted in the dry scrubber over 24 hour periods. More specifically, as opposed to prior methods of operating the dry scrubber in which the alumina demand of the smelter is fed through the dry scrubber at a constant rate over a 24 hour period, in one embodiment of the present invention the alumina feed rate is increased during daylight periods to compensate for decreases in HF adsorption efficiency by alumina corresponding increases in temperature and the alumina feed rate is decreased following sunset wherein decreases in temperature restore the adsorption efficiency of alumina.

In another aspect of the present invention, a method is provided for increasing the efficiency of alumina to adsorb gaseous fluoride, such as HF. Broadly, the method includes: providing gaseous fluoride byproducts; transporting gaseous fluoride byproducts to an alumina scrubber; and adjusting a feed rate of alumina to the alumina dry scrubber to correspond to increases and decreases in alumina adsorption efficiency of gaseous fluoride byproducts resulting from temperature changes in the alumina.

In one embodiment, the decrease in the capture efficiency of alumina at least partially results from the reduction in mass transfer efficiency of gaseous HF to the alumina surface and from fluoride being released through the vaporization of moisture from the surface of reacted alumina at temperatures on the order of 100° C. (212° F.). To compensate for the decrease in capture efficiency, the alumina feed rate is increased at least at temperatures at which a reduction of mass transfer efficiency of gaseous HF to the surface of alumina is experienced. In another embodiment, the alumina feed rate is increased at least at temperatures at which adsorbed moisture is vaporized from the reacted alumina resulting in release fluoride.

As opposed to prior methods of operating the dry scrubber in which the alumina demand of the smelter is fed through the dry scrubber at a constant rate over a 24 hour period, in one aspect of the present invention the alumina demand of the smelter is still fed through the dry scrubber, but with a varied feed rate dependent on cycle time and temperature to provide optimized HF efficiency adsorption. More specifically, the alumina feed rate is increased during daylight periods to compensate for decreases in alumina HF capture efficiency corresponding to increases in dry scrubber inlet temperature, and the alumina feed rate is decreased during periods in which HF capture efficiency by alumina is restored by a decrease in dry scrubber inlet temperature following sunset, whereas the feed rate is adjusted in providing optimized HF recovery while preferably still feeding the alumina demand required of the smelter over a 24 hour period through the scrubber system.

### BRIEF DESCRIPTION OF THE DRAWINGS

FIG. 1a (side view) depicts one embodiment of a fluidized bed gaseous HF recovery dry scrubber.

FIG. 1b (side view) depicts one embodiment of an alumina injection based gaseous HF recovery dry scrubber.

FIG. 2 depicts a plot of the inlet gas temperature of an alumina-based gaseous HF recovery dry scrubber as a function of season and time.

FIGS. 3a-3b depict plots of dry scrubber inlet temperature, HF (ppm-m) concentration in the dry scrubber exhaust stack over a time period of four days, in which the alumina feed rate to the dry scrubber was maintained at a constant rate.

FIG. 4 depicts a plot of the HF concentration measured from the exhaust gas exiting the dry scrubber as a function of the gas inlet temperature of the dry scrubber.

FIG. 5 depicts a plot illustrating the effect of reducing the alumina feed rate on HF concentration in the exhaust gasses.

FIG. 6 depicts a plot of HF concentration in the exhaust stack of the dry scrubber vs. gas inlet temperature into the dry scrubber, for alumina feed rates ranging from 10 tons per hour to greater than 13 tons per hour.

FIG. 7 depicts a plot illustrating the effects of varying alumina feed rate to the dry scrubber in response to changes in gas inlet temperature on HF concentration.

### DETAILED DESCRIPTION OF PREFERRED EMBODIMENTS

The present invention provides a more efficient recovery of gaseous HF from exhaust gases, which are produced during the production of aluminum by adjusting the alumina feed rate into an alumina-based dry scrubber to correlate to elevated temperature periods corresponding to a diurnal cycle. Contrary to the prior dry scrubbing practice of operating at a constant new alumina feed rate, it has been unexpectedly discovered that diurnal and seasonal changes in ambient temperature impact the dry scrubber's efficiency for capturing fluoride from the exhaust gases.

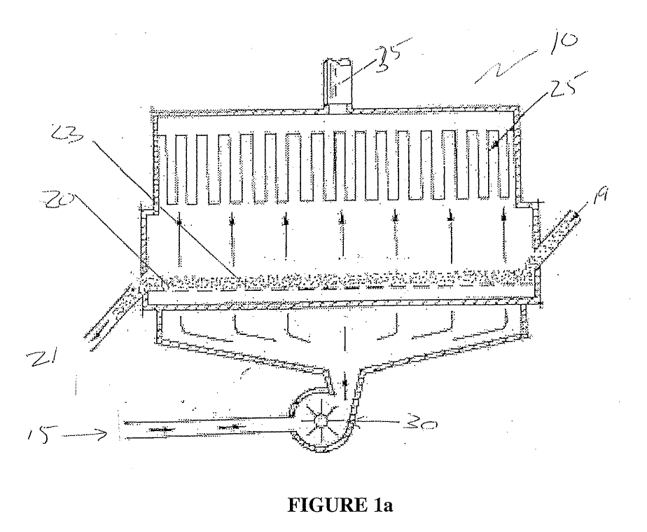

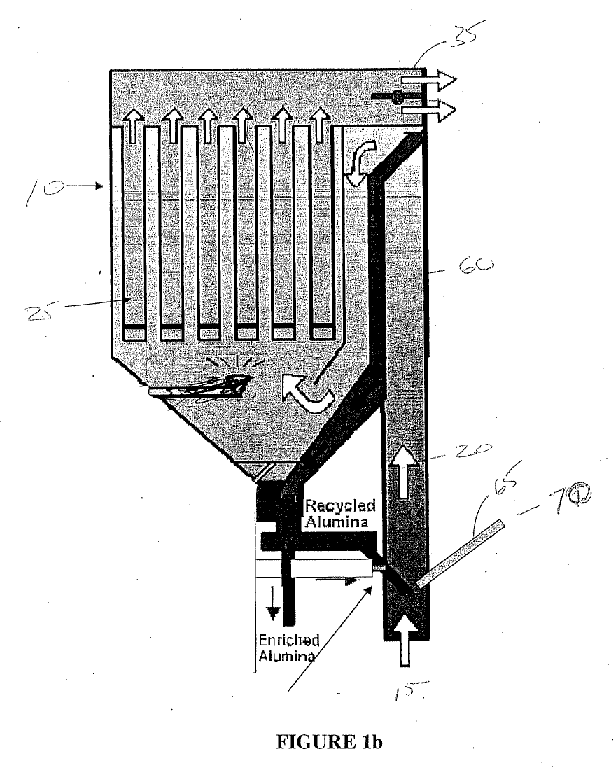

FIG. 1a depicts a fluidized bed gaseous HF recovery dry scrubber 10 including a waste gas inlet 15, fluidized alumina bed 20, dust filter 25, fan 30, and waste gas exhaust 35. In typical operation, waste gases from an aluminum producing pot (not shown) are vented into the gaseous HF recovery dry scrubber 10 through a waste gas inlet 15. The waste gas including fluoride gases are passed through a fluidized bed of alumina 20 where fluoride is adsorbed by the alumina from the waste gas. Particulate matter is removed from the waste gas by a dust filter, which may also be referred to as a fabric filter baghouse. The waste gas is then discharged from the HF recover dry scrubber 10 through the waste gas exhaust 35. In one embodiment, the fluidized alumina bed 20 comprises an alumina inlet 19 and an alumina outlet 21 with a screen (also referred to as dribble plate) 23 disposed therebetween, wherein the screen 23 has a sieve sizing to allow air fluidization of the alumina and is slightly angled to facilitate the movement of the alumina powder from the alumina inlet 19 to the alumina outlet 21. The reacted or fluoride-containing alumina is recycled into the aluminum production process.

FIG. 1b depicts an alumina injection based gaseous HF recovery dry scrubber 10 including a waste gas inlet 15, dust filter 25, fan and waste gas exhaust 35. In typical operation, waste gases from an aluminum producing pot (not shown) are vented into the gaseous HF recovery dry scrubber 10 through a waste gas inlet 15. The waste gas including fluoride gases are quickly passed through a primary reaction zone 60 where new and reacted alumina are injected into the fast moving gas stream 20, in which fluoride is adsorbed from the waste gas by the alumina (hereafter referred to as reacted alumina). The primary reaction zone 20 may include a vertical tube with injection ports 70 to allow for introduction of new or reacted alumina into the waste gases prior to the primary reaction zone 60. The largely reacted alumina and bath fines are then removed from the waste gas by a dust filter 25, which may also be referred to as a fabric filter baghouse. The waste gas is then discharged from the HF recover dry scrubber 10 through the waste gas exhaust 35. It is further noted that the majority of the largely reacted alumina and bath fines, which do not reach the dust filter 25 collect towards the base of the scrubber 10, wherein the enriched or fluoride-containing alumina is recycled into the aluminum production process.

To transport the waste gases produced during the alumina smelting process from the pots to the dry scrubber, including fluidized bed dry scrubbers, as depicted in FIG. 1a, and injection based dry scrubbers, as depicted in FIG. 1b, hooding may be employed, as known within the art.

Prior to the present invention, the alumina feed rate for dry scrubber operations was typically based on fixed year-round alumina consumption rate based from measurements taken from the commissioning of the dry scrubber. Previously, the alumina feed rate was typically set to the maximum sustainable throughput matching the alumina demand (including reacted and non-reacted alumina) of the smelter, which did not account for the reduction in capture efficiency occurring during the peak temperatures experienced during daylight hours and resulting in increased HF emission from the dry scrubber

The present invention provides a more efficient recovery of gaseous HF by adjusting the alumina feed rate to correlate to temperature changes in the waste gas inlet to the dry scrubber 21, wherein temperature changes in the waste gas inlet 15 have been correlated to the higher temperatures occurring during daylight hours and lower temperatures following sunset. In a preferred embodiment, the total alumina fed through the dry scrubber over a 24 hour period is equivalent to the alumina demand of the aluminum smelter. The “feed rate” of the alumina is the rate at which alumina powder is entered into the alumina inlet 19. Therefore, by adjusting the feed rate to the alumina scrubbers, preferably by following a diurnal cycle, the present invention unexpectedly improves aluminum smelter dry scrubber efficiency, reduces the incidence of HF emission spikes measured from the exhaust of the dry scrubber during daylight hours, and substantially reduces excess production of reacted alumina.

In the method of the present invention, a means for measuring the inlet temperature is provided at the waste gas inlet 15. In one embodiment, the alumina feed rate may be adjusted to correspond to the temperature change in the waste gas inlet 15 to the dry scrubber. The means for measuring the inlet temperature may be provide by a thermocouple, resistive temperature device or combinations thereof.

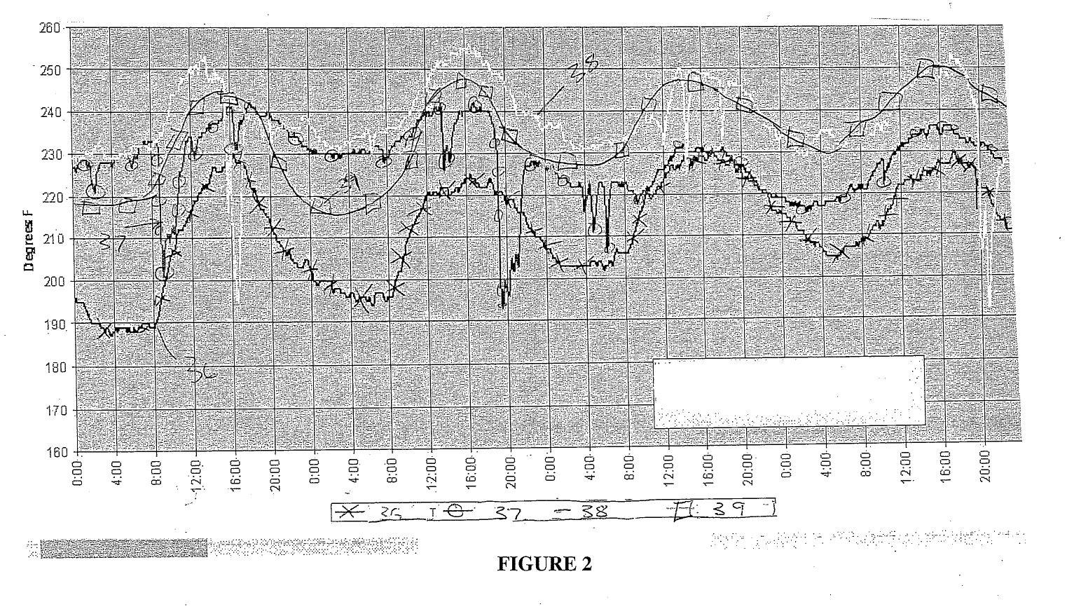

In a preferred embodiment, the alumina feed rate is adjusted to correspond with the daylight hours and evening hours of a 24 hour period, wherein the daylight hours represent a first range of ambient temperatures and the evening hours correspond to a second range of ambient temperatures. Regardless of geographic location and season, the first range of ambient temperatures have higher temperature values than the second range of ambient temperatures. Therefore, although there may be variations in the first and temperature ranges corresponding to geographic location and season, increased temperatures are experienced during daylight hours. The temperature cycle associated with time and season is further described with reference to FIG. 2.

FIG. 2 illustrates the seasonal and daily variation of waste gas inlet temperature for the first four days of January (representative of Winter and indicated by reference line 36), May (representative of Spring and indicated by reference line 37), August (representative of Summer and indicated by reference line 38) and November (representative of Fall and indicated by reference line 39) in the Southeastern region of the United States. The ambient temperature is directly proportional to the temperature at the waste gas inlet 15, wherein increases to the ambient temperature result in increases in temperature at the waste gas inlet. FIG. 2 indicates that the temperature at the waste gas inlet 15 typically increases from approximately 8:00 AM and peaks at approximately 4:00 PM, in which the increase in the temperature of the inlet gas 15 corresponds to higher temperature of the ambient air. FIG. 2 further illustrates that the increase in temperature at the waste gas inlet corresponds to the daylight hours of the Southeastern region of the United States regardless of the season. It is noted that the dramatic decreases in temperature noted at during the first day at 9:00, the second day at 20:00, and the fourth day at 20:00 are due to equipment maintenance, wherein the alumina feed rate was temporarily reduced to allow for smelter maintenance.

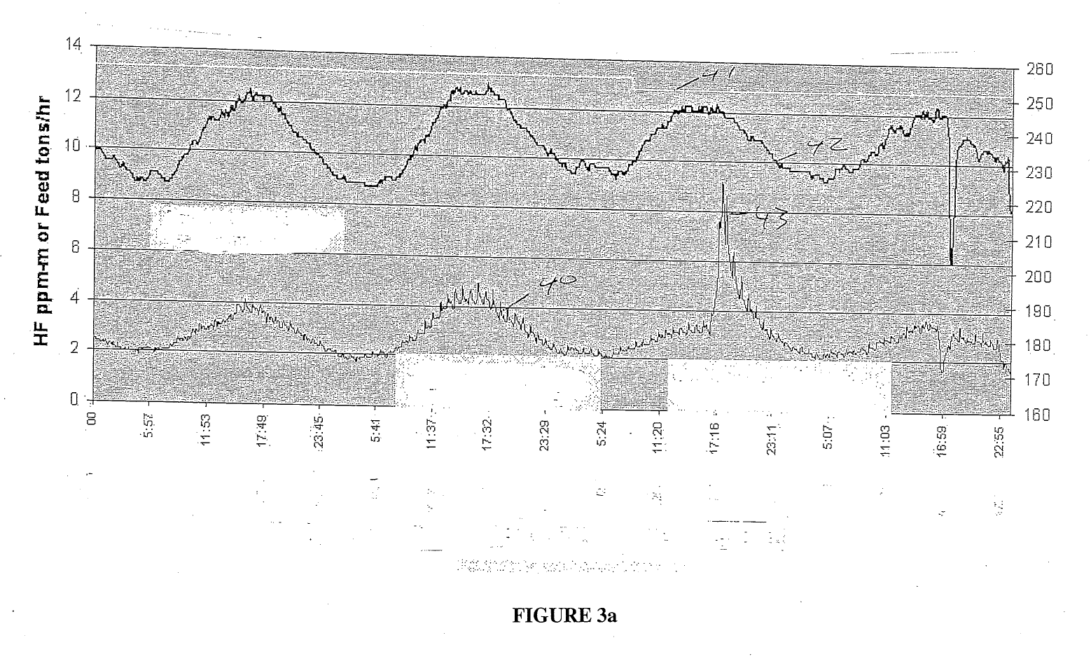

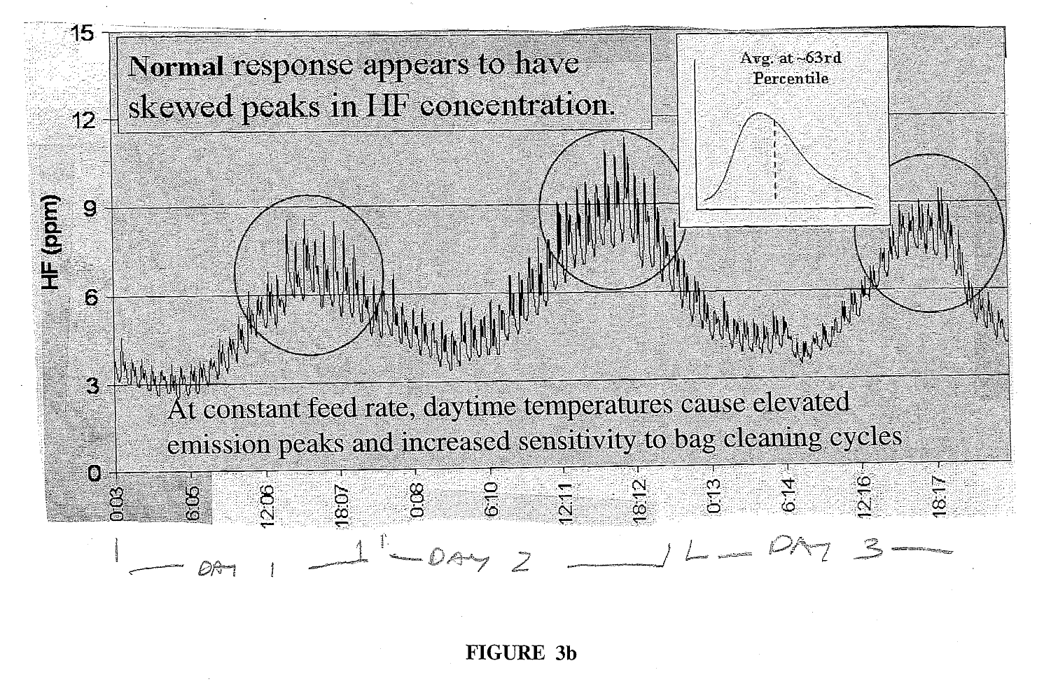

In one aspect of the present invention, the aluminum feed rate is adjusted in accordance with the correlation between the waste gas inlet temperature and HF capture efficiency in the non-reacted alumina. For the purposes of this disclosure, the term “reacted alumina” denotes that alumina has been introduced to the dry scrubber and has adsorbed a portion of fluoride gas, and the term “non-reacted alumina” denotes alumina that has not been previously introduced to the dry scrubber. The correlation between waste gas inlet temperature and the HF recapture efficiency of the dry scrubber is clearly depicted in FIGS. 3a and 3b. FIG. 3a depicts a plot of HF concentration (in parts per million over a 1.0 meter optical measurement path length (ppm-m)) at the exhaust of a alumina-based dry scrubber over a time period of four days, wherein peaks in the HF concentration were recorded between 11:00 AM and 6:00 PM, typically occurring during daylight hours. Reference line 40 represents HF emissions at the exhaust of the alumina-based dry scrubber in ppm-m. Reference line 42 of the plot in FIG. 3a is the gas inlet temperature, in which the gas inlet temperature is measured from the waste gas inlet 15, as depicted in the HF scrubbing apparatus depicted in FIGS. 1a and 1b. Reference line 41 represents a substantially constant alumina feed rate in the dry scrubber.

The relationship between temperature and HF emissions from alumina dry scrubbers is clearly illustrated by comparing the peaks for HF emissions, as represented by reference line 40, and the temperature peaks that are measured at the waste gas inlet 15, represented by reference line 42. Specifically, increases in HF emissions correlate to increases in the waste gas inlet 15 temperature. It is noted that the small peaks in the HF emissions 40 are due to bag 25 cleaning cycles and that the HF peak indicated by reference number 43 results from a disruption in the scrubbing process, particularly a clogged alumina injector or transport line. Referring to FIG. 3b, in one example, the HF concentration may peak to approximately 9 to 12 ppm during daylight hours, which correspond to the peak daytime temperature.

Alumina based dry scrubbers capture HF from the pot exhaust gas by means of a chemical reaction between the gaseous HF and the alumina. The HF capture and retention efficiency of the dry scrubber is reduced as temperature increases in the dry scrubber. This reduction in scrubbing efficiency occurs because of a reduction in mass transfer efficiency of gaseous HF to the alumina surface. More specifically, with increasing temperature in the waste gas stream to the dry scrubber, the volume of the air of the waste stream increases according to the gas, temperature, volume relationship, while the surface area of the alumina remains constant resulting in decreased mass transfer of gaseous HF to the alumina surface.

Further reductions in the capture efficiency of the dry scrubber occur when dry scrubber inlet temperature approaches or exceeds the boiling point of water (100° C. or 212° F.). This latter observation is because alumina is hygroscopic and readily adsorbs water from the atmosphere during transport to the plant and transport (often on moving belts or air slides) to the dry scrubber. As the inlet alumina is heated to elevated temperatures in the dry scrubber, the adsorbed moisture on the alumina vaporizes off the surface of the alumina. This release of surface moisture can effectively “steam” adsorbed fluoride off the surface of the alumina, thereby further compromising the capture efficiency of the dry scrubber.

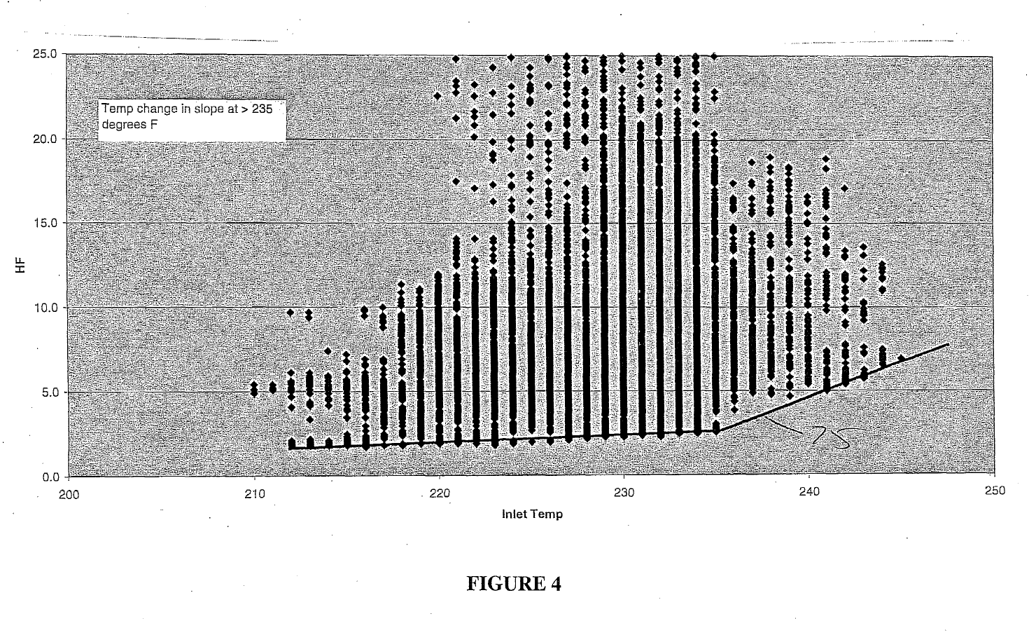

The decrease in alumina scrubbing efficiency with increasing gas inlet temperature is further illustrated by the plot of the alumina scrubbing inlet temperature vs. the HF measured from the dry scrubber exhaust depicted in FIG. 4. The data shown include 10 minute averages of the HF concentration measured from the dry scrubber exhaust taken continuously over a 7-week period at temperatures ranging from about 200° F. to greater than 245° F. The most efficient HF capture efficiency is noted by the lowest points at each temperature.

Reference line 75 represents the minimum HF measurement recorded corresponding to the gas inlet temperature. The HF concentration in the dry scrubber exhaust gas increases monotonically over temperatures ranging from 210 to 230 F indicating a gradual decrease in dry scrubber efficiency. As indicated in FIG. 4, the gradual decrease in dry scrubber efficiency is at least partially attributed to the reduction in mass transfer efficiency of gaseous HF to the alumina surface.

Still referring to FIG. 4, following the gradual increase in HF emissions, a pronounced increase in HF emissions occurs following a temperature of approximately 235° F. In the interest of further describing the invention, it is believed that at this inlet gas temperature the alumina is heated to elevated temperatures at which the adsorbed moisture on the alumina vaporizes off the surface of the alumina, wherein this release of surface moisture effectively steams the adsorbed fluoride off the surface of the alumina, thereby further compromising the capture efficiency of the dry scrubber. The elevated temperature my also induce HF generation from particulate fluorides captured within the filtered baghouse.

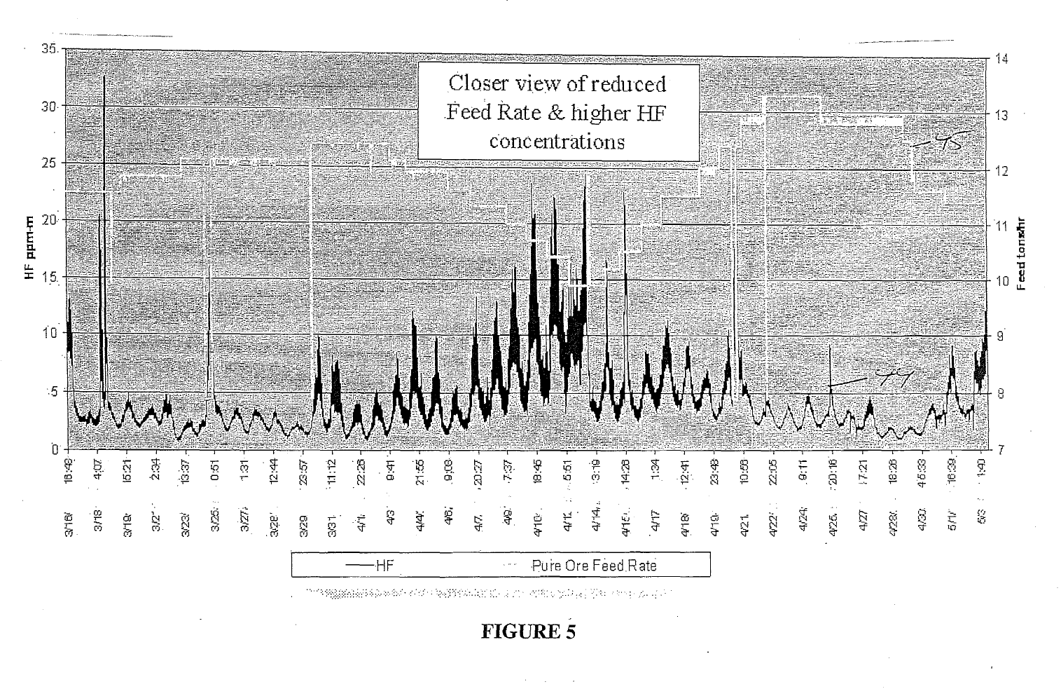

In one aspect of the present invention, the decreased efficiency of the alumina dry scrubber resulting from increased gas inlet temperature is compensated by increasing the alumina feed rate. FIG. 5 depicts a plot illustrating the effects of varying the alumina feed rate on HF emissions as measured from the exhaust of the dry scrubber. Reference line 44 depicts HF emissions in ppm-m and Reference line 45 depicts alumina feed rate in feed tons/hour, wherein the alumina feed rate is varied from approximately 10 tons/hour to approximately 13.5 tons/hour. FIG. 5 clearly illustrates that similar to increasing the inlet temperature to the dry scrubber, decreasing the feed rate of the alumina through the dry scrubber results in increased HF emissions (reduced dry scrubber efficiency). Conversely, increasing the feed rate of alumina through the fluidized alumina bed decreases HF emissions (increased dry scrubber efficiency).

It is clear from comparison of peak temperature, as indicated in FIG. 2, and peak HF generation, as indicated in FIGS. 3a and 3b, that a correlation exists between temperature and HF emission, wherein as the temperature increases efficiency of HF absorption by the alumina in the dry scrubber decreases. The alumina feed rate through the alumina fluidized bed also has an effect on HF emissions, wherein decreasing the alumina feed rate disadvantageously results in increased HF emissions, as depicted in FIG. 5.

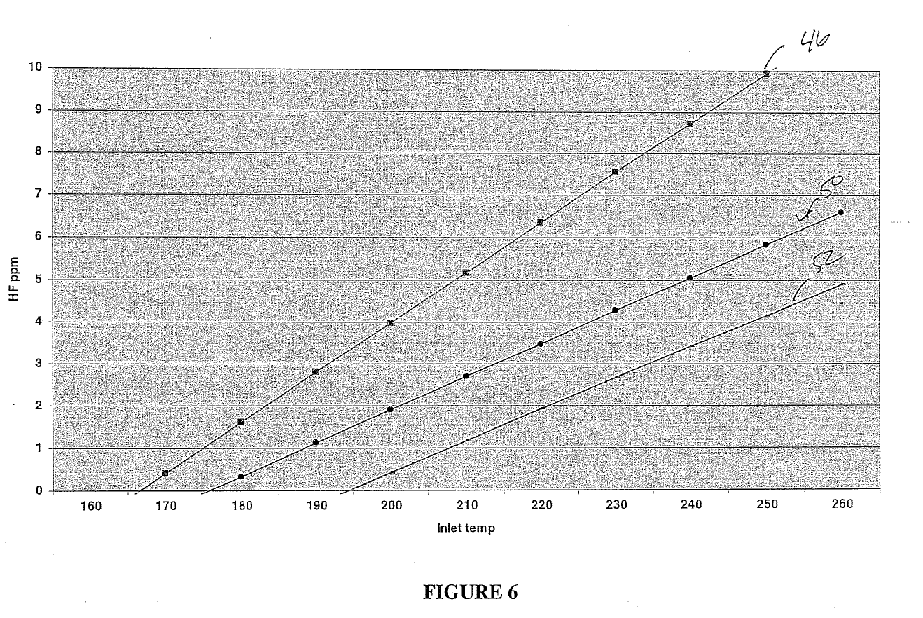

Preferably, the method of the present invention includes increasing the aluminum flow rate to compensate for the decreased dry scrubber efficiency experienced with increased inlet gas temperatures and reducing the aluminum flow rate with decreased inlet gas temperatures, wherein increased gas inlet temperatures are typically experienced during daylight hours. FIG. 6 depicts a plot of HF emissions in PPM v. the inlet temperature of the waste gases (° F.) and illustrates the effect of varying the alumina feed rate from 10 tons per hour to 13 tons per hour. Reference line 46 represents an alumina feed rate being 9.5 to 10 tons per hour. Reference line 50 represents an alumina feed rate ranging from 11.5 to 12 tons per hour. Reference line 52 represents an alumina feed rate ranging from 12.5 to 13.0 tons per hour. FIG. 6 depicts that HF concentration in the outlet of the dry scrubber increases rapidly with increasing inlet temperature when the aluminum feed rate is greater than 10% below a nominal flow rate of 11.5 tons per hour. Conversely, the HF concentration in outlet of the dry scrubber can be reduced at all operating inlet temperatures by increasing the alumina feed rate to the dry scrubber.

As discussed above, it has been unexpectedly determined that temperature has an effect on the adsorption efficiency of alumina. To reiterate, increases in temperature to the dry scrubber decrease the capture efficiency of alumina-based dry scrubbers by a combination of a reduction in the mass transfer efficiency of gaseous HF to the surface of alumina and by the vaporization of adsorbed moisture from the reacted alumina surface, which releases gaseous fluoride back into the waste gas stream. Prior to this discovery, the effects of temperature had not been contemplated, wherein the alumina feed rate to prior dry scrubbers was set to the alumina requirements of the smelter. Therefore, since prior operating practices utilized a constant feed rate of alumina to the dry scrubber regardless of inlet gas temperature, prior operating practices did not efficiently utilize alumina in the recapture of HF gasses, and in some instances required excess alumina to reduce HF emissions, which typically needed to be stored.

The inventive method by increasing the alumina feed rate to correspond to the decreased dry scrubber efficiency experienced with increased inlet gas temperatures typically experienced during daylight hours and then reducing the aluminum flow rate to correspond to decreased inlet gas temperatures in a diurnal cycle provides an optimized dry scrubber efficiency with an alumina usage that meets pot demand and substantially eliminates excess alumina usage. Preferably, the alumina feed rate is adjusted throughout the diurnal cycle to meet the alumina demand of the aluminum smelter. It has further been determined that HF concentration peaks that are typically present in the waste gas exhaust 35 of alumina dry scrubbers utilizing a constant alumina feed rate, may be substantially eliminated by increasing the alumina feed rate to correspond to the portions of alumina scrubbing cycle that occur during the peak temperature hours that typically occur during daylight.

The following example is provided to more clearly indicate the advantages and benefits of the inventive method to increase alumina dry scrubber efficiency. It is noted that the following example is provided for illustrative purposes and is not deemed to limit the scope of the present disclosure.

### EXAMPLE

The HF concentration peaks measured in the waste gas exhaust 35 may be substantially eliminated by increasing the alumina feed rate to correspond to the portions of alumina scrubbing cycle that occur during the peak temperature hours of the day, which typically occur during daylight.

The alumina feed rate was varied from less than 10 tons per hour to approximately 15 tons per hour in a fluidized bed dry scrubber located in Mt. Holly, S.C., for a time period of approximately five days during the month of July. The alumina feed rate was varied to increase feed rate during daylight hours during a time period ranged from approximately 6-10 am to approximately 6-10 pm and decrease the feed rate following sunset for a time period ranging from 6-10 pm to 6-10 am.

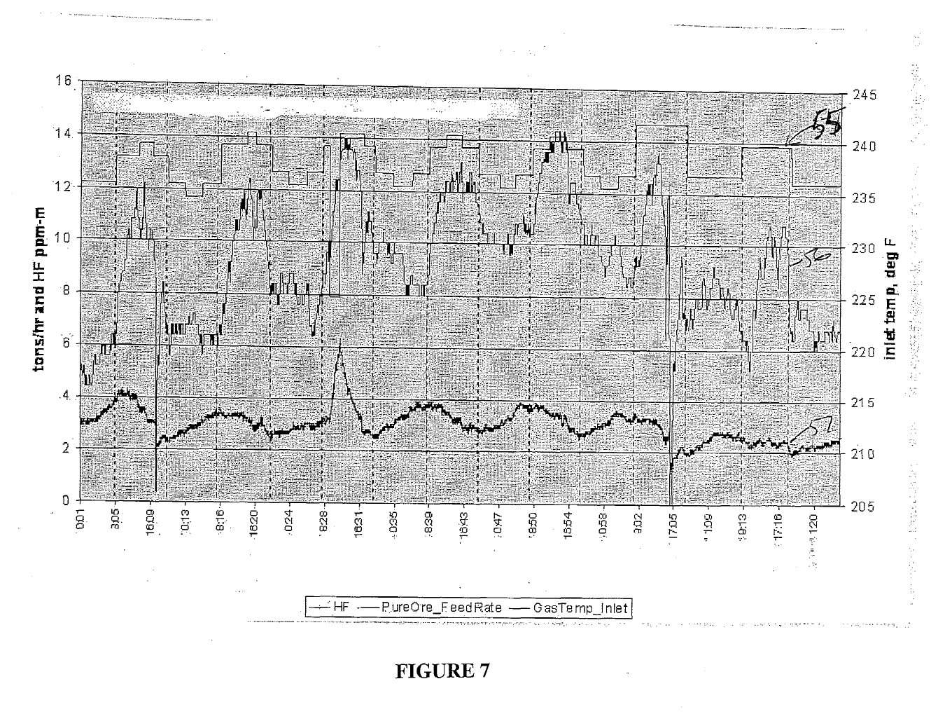

Referring to FIG. 7, a plot is provided depicting the effects of varying the alumina feed rate to correspond to changes in the inlet temperature on the HF recovery dry scrubber. The alumina feed rate is depicted by the data line corresponding to reference number 55. The peaks in alumina feed rate corresponded to peaks in the inlet temperature to the HF recovery dry scrubber, wherein the data line indicated by reference number 56 represented the inlet temperature. The data line depicted by reference number 57 represents the HF concentration measured in the dry scrubber exhaust. As depicted in FIG. 7, by varying the alumina feed rate to correspond to increases in gas inlet temperature HF concentration peaks may be substantially eliminated. It is noted that the HF peak present at data point 58 corresponds to a process check, in which the alumina feed rate was dropped to 8 tons per hour.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A method of reducing fluoride generation from aluminum smelting comprising:
providing alumina at a preselected feed rate to pots containing an aluminum producing molten electrolyte, wherein the aluminum producing molten electrolyte evolves gaseous fluoride byproducts;
transporting the gaseous fluoride byproducts to alumina-based dry scrubbers, wherein the alumina scrubbers absorb at least a portion of the gaseous fluoride byproducts;
determining the inlet temperature into the dry scrubber; and
adjusting the alumina feed rate to the dry scrubber to optimize the capture efficiency of the gaseous fluoride byproducts, wherein adjusting the alumina feed rate includes increasing the alumina feed rate to correspond to a first temperature and decreasing the feed rate to correspond to a second temperature, wherein the first temperature is greater than the second temperature.

2. The method of claim 1 wherein said preselected feed rate to the pots corresponds to an alumina demand of an alumina smelting process.

3. The method of claim 1 wherein a base alumina feed rate is equivalent to a constant feed rate required to feed the alumina demand of the smelter to the dry scrubber over a 24 hour period.

4. The method of claim 3 wherein adjusting the alumina feed rate comprises increasing the alumina feed rate by up to approximately 25% corresponding to the first temperature and decreasing the alumina feed rate by tip to approximately 25% from the base alumina feed rate corresponding to the second temperature.

5. The method of claim 1 further comprising increasing the alumina feed rate when a gas inlet temperature approaches approximately 200° F. or greater.

6. The method of claim 1 wherein the alumina based dry scrubber is an injection based dry scrubber, a fluidized bed dry scrubber, or a combination thereof.

7. The method of claim 1 comprising adjusting the alumina feed rate to correspond with a diurnal cycle.

8. The method of claim 7 wherein the first temperature corresponds to daylight hours of the diurnal cycle and the second temperature corresponds to sunset hours of the diurnal cycle.

9. The method of claim 8 wherein the first temperature is greater than 200° F. and the second temperature is less than 212° F.

10. The method of claim 1 wherein adjusting the feed rate of alumina maximizes absorption in the alumina scrubbers to provide substantially minimized gaseous fluoride byproduct in an exhaust of the alumina scrubber.

11. The method of claim 1 wherein said aluminum producing molten electrolyte comprises sodium aluminum fluoride, and said alumina scrubbers comprise alumina powder that reacts with said gaseous fluoride byproducts producing reacted alumina.

12. The method of claim 1 further comprising adding reacted alumina from said alumina scrubbers to the aluminum producing molten electrolyte.

13. A method of reducing fluoride generation:
producing gaseous fluoride byproducts;
transporting gaseous fluoride byproducts to an alumina scrubber; and
adjusting a feed rate of alumina to the alumina dry scrubber to correspond to increases and decreases in dry scrubber efficiency of gaseous fluoride byproducts resulting from temperature changes in the alumina.

14. The method of claim 13 comprising increasing the feed rate of alumina at temperatures corresponding to a reduction in the mass transfer efficiency of gaseous HF to the alumina surface.

15. The method of claim 13 comprising increasing the alumina feed rate at temperatures corresponding to temperatures at which moisture is vaporized from reacted alumina

16. The method of claim 15 further comprising increasing the alumina feed rate when the temperature approaches approximately 200° F. or greater.

17. The method of claim 13 wherein a base alumina feed rate is equivalent to a constant feed rate required to feed the alumina demand of the smelter to the dry scrubber over a 24 hour period.

18. The method of claim 17 wherein adjusting the alumina feed rate comprises increasing the alumina feed rate by up to approximately 20% corresponding to the first temperature and decreasing the alumina feed rate by tip to approximately 20% from the base alumina feed rate corresponding to the second temperature.

19. The method of claim 13 wherein the alumina based dry scrubber is an injection based dry scrubber or a fluidized bed dry scrubber.

20. The method of claim 13 wherein producing the gaseous HF products includes aluminum producing molten electrolyte comprising sodium aluminum fluoride.
